(19) United States
(12) Patent Application Publication
(10) Pub. No.: US 2009/0150167 A1
(43) Pub. Date: Jun. 11, 2009

(54) METHOD FOR ORGANIZING DATA PRESENTED TO A USER IN A VEHICLE

(75) Inventors: Russell A. Patenaude, Macomb Township, MI (US); Anthony J. Sumcad, Southfield, MI (US)

Correspondence Address: Julia Church Dierker;Dierker & Associates, P.C., 3331 W. Big Beaver Road, Suite 109, Troy, MI, 48084-2813, US

(73) Assignee: GENERAL MOTORS CORPORATION, DETROIT, MI (US)

(21) Appl. No.: 11/952,271

(22) Filed: Dec. 7, 2007

(51) Int. Cl. G06Q 99/00

(52) U.S. Cl. 705/1

(57) ABSTRACT

A method for organizing data presented to a user in a vehicle includes monitoring, at a call center, a routine of the user. Monitoring takes into account a then-current day, a then-current time of day, a then-current vehicle location, and a point of interest associated with the routine. At least one point of interest parameter, a time of day parameter, a day parameter, and a vehicle location boundary is generated based on the user's routine. The method further includes recognizing that the user is outside the vehicle location boundary on a day associated with the day parameter and at a time associated with the time of day parameter. The call center generates at least one datum based on the at least one point of interest parameter and a then-current location of the vehicle, and transmits the at least one datum to a telematics unit operatively disposed in the vehicle.

### TECHNICAL FIELD

The present disclosure relates generally to method(s) for organizing data presented to a user in a vehicle.

### BACKGROUND

Destinations, points of interest, turn-by-turn routes, and/or other similar information may currently be downloaded into an in-vehicle directory. A user may generate the information remotely (e.g., via a website) and then download the information to the vehicle for later retrieval and route generation. In some instances, all of the information is saved in a single directory, which may become relatively cluttered and unorganized.

Generally, the directory entries are updated manually via the user. Thus, to maintain an updated and current list, the user has to diligently and/or continuously update the list. This, however, may be relatively time consuming and, in some instances, tedious for the user.

### SUMMARY

A method for organizing data presented to a user in a vehicle is disclosed herein. Examples of the method include monitoring, at a call center, a routine of the user. Monitoring takes into account a then-current day, a then-current time of day, a then-current vehicle location, and a point of interest associated with the routine. At least one point of interest parameter, a time of day parameter, a day parameter, and a vehicle location boundary is generated based on the user's routine. The method further includes recognizing that the user is outside the vehicle location boundary on a day associated with the day parameter and at a time associated with the time of day parameter. The call center generates at least one datum based on the at least one point of interest parameter and a then-current location of the vehicle, and transmits the at least one datum to a telematics unit operatively disposed in the vehicle.

### BRIEF DESCRIPTION OF THE DRAWINGS

Features and advantages of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram depicting an example of a system for organizing data presented to a user in a vehicle;

FIG. 2 is a flow diagram depicting an example of a method of organizing data presented to a user in the vehicle; and

FIG. 3 is a schematic flow diagram depicting an example of some of the system components and the method for organizing data presented to a user.

### DETAILED DESCRIPTION

Examples of the method as disclosed herein advantageously allow updated and current destinations, points of interest, turn-by-turn routes, and/or other like information to be presented to a user in an organized manner. This may be accomplished by generating, at the call center, a list of one or more destinations, points of interest, turn-by-turn routes, and/or the like based on a routine of the user and the then-current location of the vehicle. The routine of the user is monitored, and parameters (such as points of interest, day, time of day and vehicle location boundary) are generated and stored to assist in generating the list. As such, desirable information may advantageously be passed on to the vehicle user even when the user is physically located outside of the vehicle location boundary. The most relevant information (generated from the previously listed criteria) is advantageously presented to the user in the vehicle in a prioritized fashion.

Information that is generated may be stored in a larger repository of information at a call center or other online remote location, and such information is available to the user at any time. As such, large volumes of information may advantageously be stored for a particular user, and the most relevant information is presented to the user at a given time.

It is to be understood that, as used herein, the term “user” includes vehicle owners, operators, and/or passengers. It is to be further understood that the term “user” may be used interchangeably with subscriber/service subscriber.

The terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween). Additionally, two components may be permanently, semi-permanently, or releasably engaged with and/or connected to one another.

It is to be further understood that “communication” is to be construed to include all forms of communication, including direct and indirect communication. Indirect communication may include communication between two components with additional component(s) located therebetween.

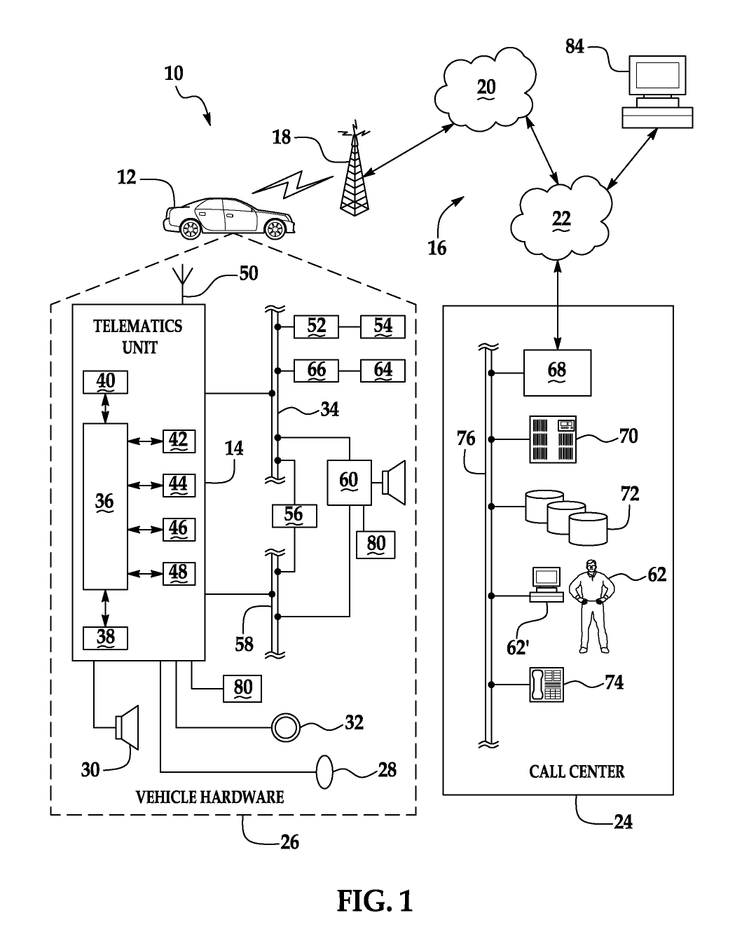

Referring now to FIG. 1, the system 10 includes a vehicle 12, a telematics unit 14, a wireless carrier/communication system 16 (including, but not limited to, one or more cell towers 18, one or more base stations and/or mobile switching centers (MSCs) 20, one or more land networks 22, and one or more service providers (not shown)), and one or more call centers 24. In an example, the wireless carrier/communication system 16 is a two-way radio frequency communication system.

The overall architecture, setup and operation, as well as many of the individual components of the system 10 shown in FIG. 1 are generally known in the art. Thus, the following paragraphs provide a brief overview of one example of such an information system 10. It is to be understood, however, that additional components and/or systems not shown here could employ the method(s) disclosed herein.

Vehicle 12 is a mobile vehicle such as a motorcycle, car, truck, recreational vehicle (RV), boat, plane, etc., and is equipped with suitable hardware and software that enables it to communicate (e.g., transmit and/or receive voice and data communications) over the wireless carrier/communication system 16. It is to be understood that the vehicle 12 may also include additional components suitable for use in the telematics unit 14.

Some of the vehicle hardware 26 is generally shown in FIG. 1, including the telematics unit 14 and other components that are operatively connected to the telematics unit 14. Examples of such other hardware 26 components include a microphone 28, a speaker 30 and buttons, knobs, switches, keyboards, and/or controls 32. Generally, these hardware 26 components enable a user to communicate with the telematics unit 14 and any other system 10 components in communication with the telematics unit 14.

Operatively coupled to the telematics unit 14 is a network connection or vehicle bus 34. Examples of suitable network connections include a controller area network (CAN), a media oriented system transfer (MOST), a local interconnection network (LIN), and Ethernet, and other appropriate connections such as those that conform with known ISO, SAE, and IEEE standards and specifications, to name a few. The vehicle bus 34 enables the vehicle 12 to send and receive signals from the telematics unit 14 to various units of equipment and systems both outside the vehicle 12 and within the vehicle 12 to perform various functions, such as unlocking a door, executing personal comfort settings, and/or the like.

The telematics unit 14 is an onboard device that provides a variety of services, both individually and through its communication with the call center 24. The telematics unit 14 generally includes an electronic processing device 36 operatively coupled to one or more types of electronic memory 38, a cellular chipset/component 40, a wireless modem 42, a navigation unit containing a location detection (e.g., global positioning system (GPS)) chipset/component 44, a real-time clock (RTC) 46, a short-range wireless communication network 48 (e.g., a Bluetooth® unit), and/or a dual antenna 50. In one example, the wireless modem 42 includes a computer program and/or set of software routines executing within processing device 36.

It is to be understood that the telematics unit 14 may be implemented without one or more of the above listed components, such as, for example, the short-range wireless communication network 48. It is to be further understood that telematics unit 14 may also include additional components and functionality as desired for a particular end use.

The electronic processing device 36 may be a micro controller, a controller, a microprocessor, a host processor, and/or a vehicle communications processor. In another example, electronic processing device 36 may be an application specific integrated circuit (ASIC). Alternatively, electronic processing device 36 may be a processor working in conjunction with a central processing unit (CPU) performing the function of a general-purpose processor.

The location detection chipset/component 44 may include a Global Position System (GPS) receiver, a radio triangulation system, a dead reckoning position system, and/or combinations thereof. In particular, a GPS receiver provides accurate time and latitude and longitude coordinates of the vehicle 12 responsive to a GPS broadcast signal received from a GPS satellite constellation (not shown).

The cellular chipset/component 40 may be an analog, digital, dual-mode, dual-band, multi-mode and/or multi-band cellular phone.

Also associated with electronic processing device 36 is the previously mentioned real time clock (RTC) 46, which provides accurate date and time information to the telematics unit 14 hardware and software components that may require and/or request such date and time information. In an example, the RTC 46 may provide date and time information periodically, such as, for example, every ten milliseconds.

The telematics unit 14 provides numerous services, some of which may not be listed herein. Several examples of such services include, but are not limited to: turn-by-turn directions and other navigation-related services provided in conjunction with the GPS based chipset/component 44; airbag deployment notification and other emergency or roadside assistance-related services provided in connection with various crash and or collision sensor interface modules 52 and sensors 54 located throughout the vehicle 12; and infotainment-related services where music, Web pages, movies, television programs, videogames and/or other content is downloaded by an infotainment center 56 operatively connected to the telematics unit 14 via vehicle bus 34 and audio bus 58. In one non-limiting example, downloaded content is stored (e.g., in memory 38) for current or later playback.

Again, the above-listed services are by no means an exhaustive list of all the capabilities of telematics unit 14, but are simply an illustration of some of the services that the telematics unit 14 is capable of offering.

Vehicle communications preferably use radio transmissions to establish a voice channel with wireless carrier system 16 such that both voice and data transmissions may be sent and received over the voice channel. Vehicle communications are enabled via the cellular chipset/component 40 for voice communications and the wireless modem 42 for data transmission. In order to enable successful data transmission over the voice channel, wireless modem 42 applies some type of encoding or modulation to convert the digital data so that it can communicate through a vocoder or speech codec incorporated in the cellular chipset/component 40. It is to be understood that any suitable encoding or modulation technique that provides an acceptable data rate and bit error may be used with the examples disclosed herein. Generally, dual mode antenna 50 services the location detection chipset/component 44 and the cellular chipset/component 40.

Microphone 28 provides the user with a means for inputting verbal or other auditory commands, and can be equipped with an embedded voice processing unit utilizing human/machine interface (HMI) technology known in the art. Conversely, speaker 30 provides verbal output to the vehicle occupants and can be either a stand-alone speaker specifically dedicated for use with the telematics unit 14 or can be part of a vehicle audio component 60. In either event and as previously mentioned, microphone 28 and speaker 30 enable vehicle hardware 26 and call center 24 to communicate with the occupants through audible speech. The vehicle hardware 26 also includes one or more buttons, knobs, switches, keyboards, and/or controls 32 for enabling a vehicle occupant to activate or engage one or more of the vehicle hardware components. In one example, one of the buttons 32 may be an electronic pushbutton used to initiate voice communication with the call center 24 (whether it be a live advisor 62 or an automated call response system 62′). In another example, one of the buttons 32 may be used to initiate emergency services.

The audio component 60 is operatively connected to the vehicle bus 34 and the audio bus 58. The audio component 60 receives analog information, rendering it as sound, via the audio bus 58. Digital information is received via the vehicle bus 34. The audio component 60 provides AM and FM radio, CD, DVD, multimedia and other like functionality independent of the infotainment center 56. Audio component 60 may contain a speaker system, or may utilize speaker 30 via arbitration on vehicle bus 34 and/or audio bus 58. The audio component 60 may also include software for receiving alerts from other vehicles 12 using the method(s) disclosed herein.

The vehicle crash and/or collision detection sensor interface 52 is/are operatively connected to the vehicle bus 34. The crash sensors 54 provide information to the telematics unit 14 via the crash and/or collision detection sensor interface 52 regarding the severity of a vehicle collision, such as the angle of impact and the amount of force sustained.

Other vehicle sensors 64, connected to various sensor interface modules 66 are operatively connected to the vehicle bus 34. Example vehicle sensors 64 include, but are not limited to, gyroscopes, accelerometers, magnetometers, emission detection and/or control sensors, and/or the like. Non-limiting example sensor interface modules 66 include powertrain control, climate control, body control, and/or the like.

In a non-limiting example, the vehicle hardware 26 includes a display 80, which may be operatively connected to the telematics unit 14 directly, or may be part of the audio component 60. Non-limiting examples of the display 80 include a VFD (Vacuum Fluorescent Display), and LED (Light Emitting Diode) display, a driver information center display, a radio display, an arbitrary text device, a heads-up display (HUD), and LCD (Liquid Crystal Diode) display, and/or the like.

Wireless carrier/communication system 16 may be a cellular telephone system or any other suitable wireless system that transmits signals between the vehicle hardware 26 and land network 22. According to an example, wireless carrier/communication system 16 includes one or more cell towers 18, base stations and/or mobile switching centers (MSCs) 20, as well as any other networking components required to connect the wireless system 16 with land network 22. It is to be understood that various cell tower/base station/MSC arrangements are possible and could be used with wireless system 16. For example, a base station 20 and a cell tower 18 may be co-located at the same site or they could be remotely located, and a single base station 20 may be coupled to various cell towers 18 or various base stations 20 could be coupled with a single MSC 20. A speech codec or vocoder may also be incorporated in one or more of the base stations 20, but depending on the particular architecture of the wireless network 16, it could be incorporated within a Mobile Switching Center 20 or some other network components as well.

Land network 22 may be a conventional land-based telecommunications network that is connected to one or more landline telephones and connects wireless carrier/communication network 16 to call center 24. For example, land network 22 may include a public switched telephone network (PSTN) and/or an Internet protocol (IP) network. It is to be understood that one or more segments of the land network 22 may be implemented in the form of a standard wired network, a fiber of other optical network, a cable network, other wireless networks such as wireless local networks (WLANs) or networks providing broadband wireless access (BWA), or any combination thereof.

Call center 24 is designed to provide the vehicle hardware 26 with a number of different system back-end functions and, according to the example shown here, generally includes one or more switches 68, servers 70, databases 72, live and/or automated advisors 62, 62′, as well as a variety of other telecommunication and computer equipment 74 that is known to those skilled in the art. These various call center components are coupled to one another via a network connection or bus 76, such as the one (vehicle bus 34) previously described in connection with the vehicle hardware 26.

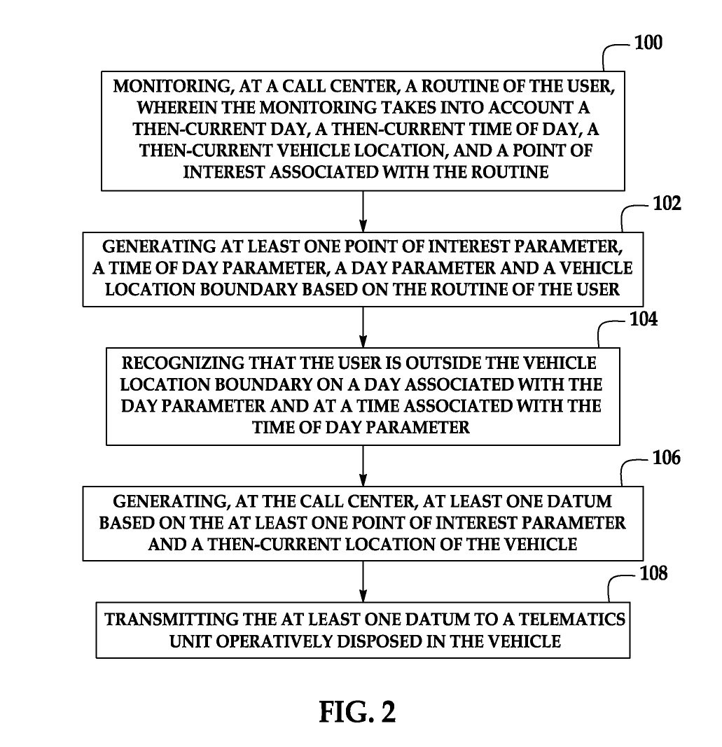

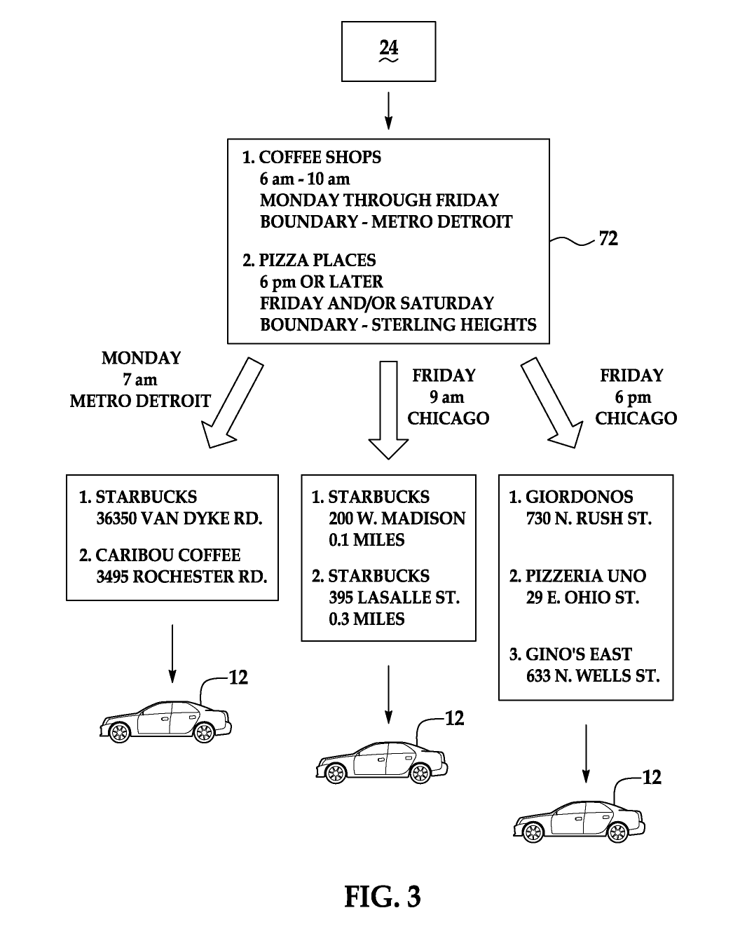

The call center 24 may be configured to store at least one parameter (e.g., a destination/point of interest, day, time of day, user preference, or combinations thereof) and a vehicle location boundary associated with the parameters. Generally, the parameter(s) are generated by the call center 24 based on the routine or habit of the user. It is to be understood that additional parameter(s) may also be pre-selected by a user based on personal preferences of the user. These instances will be described further hereinbelow in conjunction with FIGS. 2 and 3.

The live advisor 62 may be physically present at the call center 24 or may be located remote from the call center 24 while communicating therethrough.

Switch 68, which may be a private branch exchange (PBX) switch, routes incoming signals so that voice transmissions are usually sent to either the live advisor 62 or an automated response system 62′, and data transmissions are passed on to a modem or other piece of equipment for demodulation and further signal processing. The modem preferably includes an encoder, as previously explained, and can be connected to various devices such as the server 70 and database 72. For example, database 72 may be designed to store subscriber profile records (including destination/point of interest parameters/information), subscriber behavioral patterns, or any other pertinent subscriber information. Although the illustrated example has been described as it would be used in conjunction with a manned call center 24, it is to be appreciated that the call center 24 may be any central or remote facility, manned or unmanned, mobile or fixed, to or from which it is desirable to exchange voice and data communications.

It is to be understood that, although a service provider (not shown) may be located at the call center 24, the call center 24 is a separate and distinct entity from the service provider. In an embodiment, the service provider is located remote from the call center 24. A service provider provides the user with telephone and/or Internet services. In an embodiment, the service provider is a wireless carrier (such as, for example, Verizon Wireless®, AT&T®, Sprint®, etc.). It is to be understood that the service provider may interact with the call center 24 to provide service(s) to the user.

The system 10 also includes an Internet-enabled program 84 that is in selective communication with the server 70 of the call center 24 (e.g., via wireless carrier/communication system 16 or some other suitable communication system). As such, the Internet-enabled program 84 may send information to and receive information from the call center 24, and the call center 24 may then communicate with vehicle 12. In an example, the host server of the Internet-enabled program is the server 70 of the call center 24.

An example of a method of organizing data presented to the user in the vehicle 12 is depicted in FIG. 2. The method generally includes monitoring, at a call center 24, a routine of the user, wherein the monitoring takes into account a then-current day, a then-current time of day, a then-current vehicle 12 location, and a point of interest associated with the routine, as shown at reference numeral 100; generating at least one point of interest parameter, a time of day parameter, a day parameter, and a vehicle location boundary based on the routine of the user, as shown at reference numeral 102; recognizing that the user is outside the vehicle location boundary on a day associated with the day parameter and at a time associated with the time of day parameter, as shown at reference numeral 104; generating, at the call center 24, at least one datum based on the at least one point of interest parameter and a then-current location of the vehicle 12, as shown at reference numeral 106; and transmitting the at least one datum to a telematics unit 14 operatively disposed in the vehicle 12, as shown at reference numeral 108.

It is to be understood that the term “stored parameter,” as disclosed herein, refers to a destination/point of interest, day or time of day associated with a user's route, user preference information associated with a destination/point of interest, and/or the like, and/or combinations thereof that is/are stored at a location remote from the vehicle 12. Non-limiting examples of suitable remote locations include the call center 24 (e.g., via database 72) and other online locations (e.g., a user account of an Internet-enabled program 84). Furthermore, the term “datum”, as used herein, refers to piece(s) of information (e.g., a destination, a turn-by-turn route, a point of interest, and/or the like, and/or combinations thereof) that is/are derived from, at least in part, the stored parameters.

The call center 24 determines the routine or habit of the user and generates one or more parameters based on the routine or habit. To determine the routine/habit, the call center 24 monitors the vehicle 12 (via, e.g., the GPS component 44) all or some of the time. The call center 24 may keep a log of the user's activity, including destinations and/or points of interest visited or traveled to by the user. Based on the information received by the call center 24 from monitoring the vehicle 12, the call center 24 learns those destinations and/or points of interest frequently visited or traveled to by the user, the day(s) and time of day that the user frequents the destinations/points of interest, and the geographical area that encompasses the frequently visited destinations/points of interest.

An in-vehicle unit (generally part of the telematics unit 14) may determine a set of user stop locations by monitoring geographic locations where the vehicle 12 stops within a first geographic boundary. The call center 24 may review the information gathered by the in-vehicle unit to determine the point of interest parameter and the vehicle location boundary associated with the point of interest parameter.

The learned destinations/points of interest, day(s), time of day, and geographical area are then used, by the call center 24, to generate parameters for the user's profile. Generally, the call center 24 generates at least one point of interest parameter and associates a time of day parameter, a day parameter, and a vehicle location boundary with the point of interest parameter. Each of the parameters is based on the monitored routine of the user.

The point of interest parameter may be a category of destinations or points of interest. For example, the call center 24 may select general user frequented destinations, such as, for example, coffee shops, shopping centers, local parks, etc. In other instances, the call center 24 may select specific user frequented destinations or points of interest as the parameter(s). For example, the call center 24 may recognize that the user frequents Starbucks® and Caribou®, and may select such establishments as specific point of interest parameters. It is to be understood that the call center 24 may also recognize that the user frequents many different coffee shops. In this instance, the call center 24 may specify coffee shops as a general parameter. The call center 24 may also recognize that a user frequents many coffee shops, including Starbucks®. In this instance, the call center 24 may designate coffee shops as a general parameter and Starbucks®as a specific preferred parameter within the general parameter.

In generating the point of interest parameters, the call center 24 may use a point of interest reverse look-up unit (not shown) to determine whether a user stop location geographically coincides with any point of interest. Such a look-up unit may include a general list of point of interests, which may be, for example, divided into categories, geographic regions or the like. If one user stop location does geographically coincide with a point of interest, the point of interest may be designated as a visited point of interest parameter for that user. If multiple user stop locations geographically coincide with a particular point of interest, the call center 24 may designate the point of interest as a regularly visited point of interest parameter for that user.

The day and time of day parameters respectively reflect one or more days of the week and time(s) of day at which the user frequents the destination/point of interest. The day parameter may be a single day (e.g., Monday), a category of days (e.g., weekdays, weekend days), numerous days (e.g., Monday through Friday), or any other combination that corresponds to the user's routine. The time of day parameter may be a particular time (e.g., 9 A.M.), a category of time (e.g., morning, afternoon, evening), a time range (e.g., 6 A.M. through 11:00 A.M.), or any other combination that corresponds to the user's routine. As a non-limiting example, if the monitoring reveals that the user frequents a restaurant every Friday at lunch time, the call center 24 may generate “lunch restaurant” as the point of interest parameter, “Friday” as the day parameter, and “11:30 A.M. through 1:00 P.M.” as the time parameter.

The vehicle location boundary parameter reflects a geographic area in which the user's routine generally takes place. It is to be understood that the geographic area may be a threshold distance measured from the user's garage address, a specific route that the user takes, a perimeter that includes the general area in which the routine takes place (e.g., city limits, multiple cities, etc.), or any other set boundary that corresponds to the user's routine. Using the example above, if the user frequents a restaurant at lunch time on Fridays that is within 5 miles of his/her work place, the call center 24 may designate the vehicle location boundary parameter as a circle having a five mile radius and the user's work place address as a center point.

These parameters may then be used by the call center 24 to generate at least one datum that will be transmitted to the user in the vehicle 12. It is to be understood that if a plurality of parameters is included in the user's profile, the call center 24 may create one or more parameter lists. These list(s) generally prioritize the user's parameters according to one of more user preferences (learned or supplied by the user).

The user profile including the call center 24 generated parameters is accessible by the call center 24, regardless of where the profile is stored, so that the call center 24 may extract one or more parameters therefrom. As previously mentioned, if the user profile is stored at the call center 24, the user profile is stored in and accessible from one of the databases 72. If the user profile is stored in an online location (e.g., in the user's Internet-enabled program account) remote from the call center 24, the call center 24 is allowed or has permission to remotely access the user profile.

As shown in FIG. 2, examples of the method include the call center 24 recognizing that the vehicle 12 has exceeded or is outside the vehicle location boundary at a time that is associated with the time of day parameter. In some instances, the call center 24 includes a point of interest notification unit (not shown), which determines whether the vehicle 12 is in a second geographic boundary (i.e., outside the vehicle location boundary) not including, for example, the regularly visited point of interest.

In response, the call center 24 generates an appropriate datum to transmit to the user. As previously described, the datum is a destination, point of interest, map, navigation instructions, or the like that is generated for the user based on the extracted parameters and the then-current vehicle location. The datum may be a notification of a similar point of interest in the second geographic boundary that bears common characteristics to the regularly visited point of interest. Generally, the call center 24 reviews the parameters, and determines which datum/data will fulfill a request of the user and/or may be useful to the user at that particular time, on that particular day and in that particular location. The call center 24 may use online or other resources to generate the datum/data. It is to be understood that the newly generated data may also be included in a database of data maintained and used by the call center 24.

In some instances, the call center 24 may recognize vehicle 12 start up and then review the user's profile. The call center 24 may review and extract the entire profile or just those parameters associated with the then-current day and then-current time. By comparing the extracted parameters in the profile with the then-current day, the then-current time of day and the then-current vehicle location, the call center 24 makes a determination as to which datum/data are appropriate to send to the user.

If the day, time and then-current location match the extracted parameters, the call center 24 pushes to the user datum/data (e.g., including an address and a distance from the vehicle's 12 location) that match the point of interest parameter associated with the other parameters. As a non-limiting example, if the user's profile includes Monday, 5 A.M., Starbucks®, Sterling Heights, Mich., and the call center 24 recognizes that the vehicle 12 is start up at 5:15 A.M. on a Monday morning in Sterling Heights, then the call center 24 may transmit to the vehicle 12 a list of the nearest Starbucks® locations.

If the day and time match the extracted parameters, but the then-current vehicle location is outside of the vehicle location boundary, the call center 24 pushes to the user datum/data that match or are similar to the point of interest parameter, but that are located near the then-current vehicle 12 position.

As previously mentioned, the call center 24 bases the datum on the point of interest parameter, the time of day parameter, the day parameter and the fact that the vehicle 12 is outside the vehicle location boundary. As such, the extracted point of interest parameter(s) is/are one of the criteria used by the call center 24 to generate the at least one datum. For example, if the extracted point of interest parameter is a general category, such as coffee shops, the call center 24 generates one or more data (which, for example, may be presented to the in-vehicle user in the form of options) for any coffee shops, such as, e.g., Starbucks®, Caribou®, Beaners®, and the like. In another example, if the extracted parameter is Starbucks®, then the call center 24 may generate several data, each of which represents a different Starbucks® location, if any are available in the user's then-current location.

It is to be understood that the point of interest parameter(s) extracted by the call center 24 may depend, at least in part, on a request of the user, and any of the other previously listed criteria (i.e., the day and time at which the call center 24 is generating the datum, and the location of the vehicle 12 at the time the datum is being generated. In an example in which the call center 24 pushes a datum to the user (discussed further hereinbelow), the call center 24 may determine which point of interest parameter(s) to extract based on the other three criteria. In an example in which the user requests a particular datum (also discussed further hereinbelow), the call center 24 may determine which point of interest parameter(s) to extract based on the user's request.

In addition to the extracted point of interest parameter(s), the datum/data generated may also based on a then-current day, a then-current time of day, and a then-current location of the vehicle 12. It is to be understood that the “then-current day” refers to the day of the week (e.g., Monday, Tuesday, Wednesday, etc.) on which the datum is being generated; the “then-current time of day” refers to the time of day at which the datum is being generated; and the “then-current location of the vehicle 12” refers to the geographic location (e.g., determined by GPS coordinates) of the vehicle 12 when the datum is being generated. Therefore, when generating a datum, the call center 24 determines the day, the time, and the vehicle 12 location.

In an example, the call center 24 generates “breakfast restaurants” as a point of interest parameter based on the user's routine. If the user leaves for work on a Monday morning at 6:00 A.M. and requests directions for a restaurant, the call center 24 may select breakfast restaurants as the parameter (generally basing this selection on the time of day at which the request is made), and may generate a datum for any type of breakfast restaurant (e.g., International House of Pancakes®, Elias Brothers®, Dunkin Donuts®, etc.) within a predetermined radius of the user's vehicle 12 that is open for breakfast at 6:00 A.M. on Monday mornings. Such datum/data may be sent to the user.

In another example, the call center 24 generates “donut shops for breakfast on Mondays” as the point of interest, time and day parameters based on the user's routine. Every Monday morning, the call center 24 may provide to the user (e.g., upon recognition of vehicle 12 startup) specific donut shops within the predetermined radius of the user's vehicle 12 that are open for breakfast on Mondays at the time at which the user is in the vehicle 12. In this example, it is to be understood that the list of data may vary from Monday to Monday, depending, at least in part, on the time and location of the vehicle 12. As such, the call center 24 adjusts the datum upon recognizing that the vehicle 12 is located outside the vehicle location boundary parameter. As an example, if the user is traveling and the vehicle 12 is located in a different city, the donut shops listed as data will be different than if the user were leaving from his/her garage address.

If more than one datum is generated, the call center 24 may sort the data based on the parameter(s), and in some instances, on other user preferences stored in his/her profile. The data may generally be sorted based on an order of relevancy, and then transmitted to the vehicle 12 user in that order.

It is to be understood that the order of relevancy may reflect the datum destination with respect to the then-current vehicle 12 location. For example, the closest datum destination with respect to the then-current location of the vehicle 12 may be listed first, with each subsequent listing being the next furthest from the vehicle 12. For example, if the extracted parameters include “Italian restaurants for lunch on Mondays at 11:30 A.M. in the metro Detroit area”, the call center 24 may generate several available Italian restaurants as data to present to the user. The call center 24 may then prioritize the Italian restaurant data so that the Italian restaurant closest to the then-current location of the vehicle 12 is listed first, and the remaining restaurants are listed in descending order based on the restaurant's distance from the then-current location of the vehicle 12.

It is to be further understood that the order of relevancy may also reflect a destination location that is suitable for the then-current time of day. Using the Italian restaurant parameter example provided above, if at least one of the Italian restaurants starts serving lunch at 1:00 p.m. on Mondays (as opposed to 11:30 A.M.), those restaurants would be considered less relevant by the call center 24 and provided to the user as data near the end of the sorted list. Furthermore, if one of the Italian restaurants in the area of the vehicle 12 were closed on Mondays, the call center 24 would exclude them from the list.

In some instances, the method as disclosed herein may be initiated by the user. Generally, the user generates a request via the telematics unit 14, which transmits the request to the call center 24. The request may be initiated via verbal communication, physical communication, and/or combinations thereof. Physically initiating the request may be accomplished via a button press (using buttons, knobs, switches, keyboards, and/or controls 32), a touch screen, or the like located in the vehicle 12 and operatively connected to the telematics unit 14. Verbally initiating the request may take place via, e.g., the microphone 28 associated with the telematics unit 14. When the user initiates a request, the call center 24 may determine the location the vehicle 12 by allowing the user to inform the call center 24 of his/her position, and/or via the location detection system 44. In response to the request, the call center 24 generates one or more data as previously described.

In other instances, the method may be initiated by the call center 24. Generally, such instances involve the call center 24 pushing one or more data to the vehicle 12 without first receiving a request from the user.

In an example, the call center 24 may flag the user profile to remind the call center 24 to push a particular datum (list of data) to the user at a particular time and/or on a particular day. For example, if the user's profile includes “coffee shops” as one of his/her point of interest parameters, the call center 24 may flag the user's profile to transmit a list of data indicating the nearest coffee shops within a predetermined radius of the vehicle 12 when the vehicle 12 is started between the hours of 6:00 A.M. and 11:00 A.M.

It is to be understood the routine/habit of the user may also be updated by monitoring the user's response to datum/data that are sent on a relatively regular basis (e.g., Monday through Friday, weekend lunch times, etc.). For example, if the point of interest parameter is the general category of coffee shops, the call center 24 may send a list of data (on a day and at a time corresponding to the day and time parameters in the user's profile) representing coffee shops within a 5 mile radius of the user's then-current location. If the user substantially consistently chooses to go to Caribou® coffee shops, the call center 24 may generate another parameter in the user's profile specifically for Caribou® coffee shops. After generating the parameters for the user, the call center 24 may then include the locations of various Caribou® coffee shops (as opposed to many different coffee shops) as data when the user starts the vehicle 12 Monday through Friday mornings. With both coffee shops and Caribou® in the user's parameters, the call center 24 will be aware that when the user is located in a geographical region that does not have Caribou® coffee shops, the user may still desire that the locations of other coffee shops be sent as data.

It is to be understood that when the call center 24 updates the user's profile with new parameters, the user may add to, remove, or alter such parameters by accessing his/her Internet-enabled program account or by contacting a service advisor 62, 62′ and requesting that the parameter be so updated.

In yet another example, the routine/habit of the user may be updated by monitoring the data generated by the call center 24 and thereafter selected by the user. For example, if the user substantially consistently selects Red Lobster® from a list of restaurant data generated by the call center 24 when selecting a restaurant in Detroit, the call center 24 may also generate Red Lobster® as a datum for a list of restaurants when the vehicle 12 enters other geographical regions such as, e.g., Chicago.

In some instances, the vehicle 12 may be in “sleep” mode when the call center 24 attempts to send the datum/data. In these instances, the call center 24 may store the datum/data in a temporary cache, and transmit them to the user if the vehicle 12 enters “awake” mode within time frame that the datum/data is/are stored. Otherwise, the call center 24 may delete the data when the vehicle 12 is in “sleep” mode.

If the call center 24 transmits the unsolicited list of data to the user (based on, e.g., the routine or habit of the user), the user has the option to override the transmission if the user does not want it. In some instances, the user may reject the transmission and end the communication with the call center 24. In other instances, the user may reject the transmission and request that other datum/data be sent based on a different parameter selected by the user from within the vehicle 12. In the latter situation, the call center 24 may provide the parameter list to the in-vehicle user (e.g., audibly or via display 80), and then generate new data based on the new parameter selected by the user.

In addition to the parameters generated by the call center 24 based on the routine of the user, parameter(s) may be pre-selected via the user. It is to be understood that such parameters are often based on the personal preferences of that user.

The user may input or select additional parameter(s) and/or may update the parameters generated by the call center 24 by accessing an Internet-enabled program 84 (e.g., a website). The user accesses the Internet-enabled program 84 via a computer or other electronic device (e.g., desktop, notebook, mobile phone, or personal digital assistant) configured to access the Internet. In an example, the computer or other electronic device includes, or is in communication with, an input device (e.g., a keyboard and/or mouse) and a display (e.g., a monitor and/or one or more speakers). It is to be understood that the communication between the computer or other electronic device and the server (e.g., server 70) hosting the Internet-enabled program 84 may be wired and/or wireless. The computer or other electronic device is generally at a location that is remote from the vehicle 12. However, it is to be understood that the computer or other electronic device may be a portable device that is used in the vehicle 12.

The user accesses his/her personalized account at the Internet-enabled programs 84 by inputting user-specific information. The user specific information may include, for example, the user's name, a password, an account number, and/or any other identifying information. It is to be understood that the personalized account information may be stored and/or accessed by the server (not shown) hosting the respective Internet-enabled program 84.

The Internet-enabled program 84 is generally a website associated with the call center 24 that enables a user to input destination entries, points of interest, or other locations, in addition to other user preferences associated with such destination entries, points of interest, etc. It is to be understood that this website may enable the user to save information in his/her account, and the call center 24 may, in some instances, remotely access such information from the account.

Once the user is granted access to his/her Internet-enabled program account, the Internet-enabled program 84 prompts the user to input, select or update a parameter. Such parameters include those previously described in reference to the call center 24 generated parameters. The user often accesses his/her account to update or further define parameters generated by the call center 24. As one example, if the call center 24 has defined the point of interest parameter as “coffee shops”, the user may add an additional parameter which further specifies that he/she prefers Starbucks® or Caribou®. As another example, if the call center 24 has defined the vehicle location boundary as “Detroit” and the user has recently moved outside the city limits, he/she may change the vehicle location boundary parameter to “Metro Detroit”.

Inputting the parameter generally involves the user inputting an address, a partial address (e.g., city, zipcode, etc.), a place name (e.g., points of interest), an intersection, or combinations thereof. Selecting a parameter generally involves the user selecting, from a previously generated list, a particular destination/point of interest. Inputting/selecting the parameter may also include the user inputting/selecting preferences associated with a particular destination entry. For example, a user may indicate or update the day(s) and/or time(s) that he/she frequents a particular destination entry.

It is to be understood that the number of parameters generated by the call center 24 may vary from user to user. In some instances, the routine of the user may be indicative of a single parameter (e.g., a single preferred restaurant on a particular day at a particular time). In other instances, the routine of the user may be indicative of a plurality of parameters (e.g., two or more preferred restaurants or categories on one or more days at a particular time of day).

It is to be understood that the user entered/selected parameter may be saved in his/her account, and/or may be transmitted to the server 70. In one example, the saved destination entries is/are stored at a location remote from the computer or other electronic device being used to access the Internet-enabled program 84. As such, the entries may be accessible to a user from any device capable of accessing the Internet-enabled program 84. This type of storage enables the user to retrieve the information at a later date for updating, changing or deleting such information. It is to be understood that the user's Internet-enabled program account may also function as the remote user profile that is accessible by the call center 24.

As previously mentioned, after the parameters are input/selected/updated by the user, the Internet-enabled program 84 may send such information to the server 70. The transmitted information is saved in a user profile at the call center 24. It is to be understood that a user's profile may be maintained both at the user's Internet-enabled program account and at the call center 24. The user's online account and call center profile may be linked such that when one is updated, the other is updated.

Referring now to FIG. 3, a schematic flow diagram of the method described in FIG. 2 is illustrated. Generally, one or more point of interest parameters (e.g., coffee shops, pizza places) and corresponding time, day and location parameters are created by the call center 24 after monitoring the user's routine and are stored in the user's profile in database 72.

The call center 24 access the user's profile to extract parameters and generate data, taking into account the user's preferences (i.e., the point of interest parameters), the then-current time of day, the then-current day, and the then-current vehicle 12 location. This may occur in response to a request by the user, or the call center 24 may push the datum/data to the user.

As shown in FIG. 3, on a Monday morning at 7 A.M. when the vehicle 12 is located in Detroit, the call center 24 may send a list of data to the user in the following order 1) Starbucks®, and 2) Caribou®, which represents the locations that are closest to the vehicle's 12 then-current position.

FIG. 3 also depicts the list of data that are sent to the user when the call center 24 recognizes that the vehicle 12 is located outside the vehicle location boundary parameter (i.e., Metro Detroit in this example) on Friday morning (i.e., one of the day parameters in this example) at 9 A.M. (within the time parameter in this example). The call center 24 recognizes that while the vehicle 12 is located outside the set vehicle location parameter, the other parameters (i.e., point of interest, time and day) indicate that the user may wish to receive datum/data for coffee shops in his/her then-current location. As shown in FIG. 3, the call center 24 generates two data indicating the closest coffee shops to the user's location in Chicago on Friday at 9 A.M.

FIG. 3 also depicts that the list of data sent to the user may be specific for a user on a Friday night at 6 p.m. when the vehicle 12 is located in Chicago. In this example, the call center 24 again recognizes that the user is outside the vehicle location boundary associated with the pizza places parameter. However, because the time and day parameters match, the call center 24 may send a list of pizza places that are local to the Chicago area and that are located within a predetermined distance of the vehicle's then-current location. Note that the call center 24 filters through the point of interest parameters, and determines which is most relevant for the user, depending, at least in part, on the day, time and location.

In the examples disclosed herein, if the user has not requested such data, but wishes to obtain navigation instructions to one of the data, he/she may do so by communicating with the call center 24.

Furthermore, it is to be understood that the datum/data may be transmitted via the wireless carrier system 16 and may be provided to the user audibly or vehicle in-vehicle display 80.

While several examples have been described in detail, it will be apparent to those skilled in the art that the disclosed examples may be modified. Therefore, the foregoing description is to be considered exemplary rather than limiting.

1. A method for organizing data presented to a user in a vehicle, the method comprising:
monitoring, at a call center, a routine of the user, wherein the monitoring takes into account a then-current day, a then-current time of day, a then-current vehicle location, and a point of interest associated with the routine;
generating at least one point of interest parameter, a time of day parameter, a day parameter, and a vehicle location boundary based on the routine of the user;
recognizing that the user is outside the vehicle location boundary on a day associated with the day parameter and at a time associated with the time of day parameter;
generating, at the call center, at least one datum based on the at least one point of interest parameter and a then-current location of the vehicle; and
transmitting the at least one datum to a telematics unit operatively disposed in the vehicle.

2. The method as defined in claim 1 wherein a plurality of data is generated, and wherein the method further comprises:
sorting the plurality of data based on the at least one point of interest parameter, the day, the time, the then-current location of the vehicle, or combinations thereof; and
transmitting the plurality of data in order of relevancy based on the sorting.

3. The method as defined in claim 2 wherein the order of relevancy reflects a closest destination of each of the plurality of data with respect to the then-current location of the vehicle.

4. The method as defined in claim 1, further comprising:
pre-selecting, via the user, at least one other point of interest parameter based on personal preferences of the user; and
storing the at least one other parameter in a location remote from the vehicle.

5. The method as defined in claim 4 wherein pre-selecting the at least one other parameter is accomplished by:
accessing an Internet-enabled program;
inputting or selecting the at least one other parameter via the Internet-enabled program; and
transmitting the at least one other parameter from the Internet-enabled program to a user profile accessible by the call center.

6. The method as defined in claim 1, further comprising storing the at least one point of interest parameter, the time of day parameter, the day parameter, and the vehicle location boundary at the call center.

7. The method as defined in claim 1 wherein monitoring the routine of the user is accomplished by monitoring user selected data, monitoring user frequently visited destinations, monitoring frequent user navigation requests, or combinations thereof.

8. The method as defined in claim 1 wherein the at least one datum is generated by the call center upon request of the user, or by the call center unsolicited by the user.

9. The method as defined in claim 1 wherein the at least one datum is selected from a destination, a turn-by-turn route, a point of interest, or combinations thereof.

10. A method for organizing data presented to user in a vehicle, the method comprising:
storing a plurality of data at a call center;
monitoring, via the call center, a routine of the user, wherein the monitoring takes into account a then-current day, a then-current time of day, a then-current vehicle location, and a point of interest associated with the routine;
generating at least one point of interest parameter, a time of day parameter, a day parameter, and a vehicle location boundary based on the routine of the user;
storing the at least one point of interest parameter, the time of day parameter, the day parameter, and the vehicle location boundary in a user profile;
recognizing that a user is outside the vehicle location boundary on a day associated with the day parameter and at a time associated with the time of day parameter;
extracting, in response to the recognizing, the at least one point of interest parameter from the user profile;
generating, at the call center, a prioritized list including at least one of the plurality of data, the prioritized list based on the at least one point of interest parameter and a then-current location of the vehicle; and
transmitting the prioritized list to the vehicle.

11. The method as defined in claim 10 wherein each of the plurality of data is selected from a destination, a point of interest, a turn-by-turn route, or combinations thereof.

12. A system for organizing data to present to a user in a vehicle, the system comprising:
means for monitoring a routine of the user, wherein the means for monitoring takes into account a then-current day, a then-current time of day, a then-current vehicle location, and a point of interest associated with the routine;
means for generating at least one point of interest parameter, a time of day parameter, a day parameter, and a vehicle location boundary based on the routine of the user;
means for recognizing that the user is outside the vehicle location boundary on a day associated with the day parameter and at a time associated with the time of day parameter;
means for generating at least one datum based on the at least one point of interest parameter and a then-current location of the vehicle; and
a telematics unit operatively disposed in the vehicle and configured to receive the at least one datum from the means for generating.

13. The system as defined in claim 12 wherein the means for generating is configured to generate a plurality of data, and wherein the system further comprises:
means for sorting the plurality of data based on the at least one point of interest parameter, the day, the time, the then-current location of the vehicle, or combinations thereof; and
means for transmitting the plurality of data in order of relevancy based on the sorting.

14. The system as defined in claim 13 wherein the order of relevancy reflects a closest destination of each of the plurality of data with respect to the then-current location of the vehicle.

15. The system as defined in claim 12, further comprising:
means for pre-selecting, via the user, at least one other point of interest parameter based on personal preferences of the user; and
means for storing the at least one other parameter in a location remote from the vehicle.

16. The system as defined in claim 12, further comprising means for storing the at least one point of interest parameter, the time of day parameter, the day parameter, and the vehicle location boundary.

17. The system as defined in claim 12 wherein the at least one datum is generated by the means for generating upon request of the user, or by the means for generating unsolicited by the user.

18. The system as defined in claim 12 wherein the at least one datum is selected from a destination, a turn-by-turn route, a point of interest, or combinations thereof.

19. A system, comprising:
an in-vehicle unit for determining a set of user stop locations by monitoring geographic locations where a vehicle stops within a first geographic boundary;
a point of interest reverse look-up unit for determining whether one of the user stop locations geographically coincides with a point of interest, and for designating the point of interest as a visited point of interest if the one of the user stop locations geographically coincides with the point of interest, and for designating the point of interest as a regularly visited point of interest if at least one other of the user stop locations geographically coincides with the point of interest;
a point of interest notification unit for determining whether the vehicle is in a second geographic boundary not including the regularly visited point of interest; and
when the vehicle is in the second geographic boundary, providing, to a driver of the vehicle, a notification of a similar point of interest in the second geographic boundary that bears common characteristics to the regularly visited point of interest.
